(19) United States
(12) Patent Application Publication
(10) Pub. No.: US 2012/0304552 A1
(43) Pub. Date: Dec. 6, 2012

(54) CARPORT STRUCTURE AND METHOD OF CONSTRUCTION THEREFOR

(76) Inventor: Andrew Cox, Bradford on Avon (GB)

(21) Appl. No.: 13/513,753

(22) PCT Filed: Dec. 6, 2010
(86) PCT No.: PCT/IB10/55594

§ 371 Date: Aug. 8, 2012

(30) Foreign Application Priority Data
Dec. 4, 2009 (IT) VR2009A000214

(51) Int. Cl. E04H 6/02; B23P 11/00

(52) U.S. Cl. 52/73; 29/428

(57) ABSTRACT

The present disclosure relates to a modular carport structure comprising one upright member (2), a cantilever roof structure (3) designed to be supported by this upright member (2), and star-like connecting means (4) designed to support and connect the cantilever roof structure (3) to the upright member (2).

The present invention relates to a carport structure designed to be installed in open urban areas, such as car parks, airports and industrial sites.

Carport structures have already been proposed which usually comprise a pair of upright members arranged to support a roof structure designed to cover or shelf one or more cars parked underneath. Such carports are usually installed on mass concrete foundations and can be joined to one another to form a single or double row (i.e. “back to back”) configuration.

Conventional carports have a number of drawbacks.

First of all, the upright member or members of a carport are normally mounted by casting expensive concrete mass poured foundations in the parking bay which require extensive ground works and surface disturbance or by means of above ground concrete ballast foundations which limit the space available for an easy paring of the cars. Moreover, when twin post or upright members are used for supporting a roof structure, access to lateral car doors of parked cars is often unduly limited due to the number and position of said upright members.

Another drawback is that conventional cantilevered carports which do not impede parking or vehicle access include inefficient large steel beams necessary to take the imposed bending forces from typical roof loads (e.g: snow), thus resulting in very heavy roof structures which require high assembling skill and long times for being installed.

Document DE-296 11 238, for example, discloses a carport structure having a tubular upright member anchored to the ground by means of a steel plate and extending vertically upwards, in use. The upright member has plate-like means angularly spaced from one another around its upper portion. Each plate-like means is secured to the proximal end of a respective cantilever beam element, whose other distal end is secured to a funnel-shaped roof structure.

The funnel-shaped roof structure is made of stainless steel with a through opening right above the upright member, so that rain from the roof can flow into an underneath funnel element placed on the upper end of the upright member, and having its outlet mouth discharging into the tubular upright member. Thus, rain water from the roof can be discharged through the tubular upright member.

FR-2 034 093 teaches a tubular support structure designed to support a roof structure comprising a main upright member extending vertically upwards and connected, at its upper end, with a cross-shaped plate to which four overhanging upwards extending arms are welded. The roof structure is made of transversal, longitudinal and diagonal rafters joined together by join members.

Carports totally made of aluminum have also been proposed which are lighter in weight, but have the inconvenience of involving a complicated structure which is difficult and thus costly to manufacture and, usually require more upright members to take the roof loads, thus limiting access to car spaces and vehicle doors. Furthermore aluminum structures can be problematic to recycle.

The roof structures in conventional carports are often designed also to support solar collectors or panels to obtain electric energy from the sun. EP-1 626 140 discloses a carport structure having an upright member extending vertically upwards, and provided with two cantilever upwards extending beams at the upper end thereof. The two cantilever beams extend in opposite direction with respect to the upright member so as to form a “T-shaped” inwardly inclined supporting structure. The cantilever beams support a roof structure and star-like support means at their free ends. Each support means carries a photovoltaic generator comprising a frame for supporting a plurality of photovoltaic (or PV) panels. Each photovoltaic generator can be inclined with respect to ground, and also rotated so as to face always the sun.

The inconvenience with such conventional carports supporting solar panels is that they are usually designed to support only panels of specified dimensions and types. This constitutes a limit in that the roof becomes obsolete whenever a new more productive solar panel type, but different in size, becomes available on the market.

The roof structures of some carports also include a secondary water proof membrane under the solar panels thus increasing cost, part count and complexity of assembly.

The main object of the present invention is that of providing carports which ensures easy access and comfortable space also for full opening of lateral car doors while also minimizing materials for the roof support structure through means efficient structural design.

Another object of the present invention is that of providing a carport structure which is completely modular, and can be transported with minimal space wastage and easily installed and rapidly assembled without the need of skilled personnel.

Another object of the present invention is that of providing a means of assembling the entire cantilever roof structure at ground level, thereby eliminating working at height and the need for heavy lifting equipment for roof structure assembly.

Another object of the present invention is that of providing a highly efficient cantilevered structural ‘space frame’ design, by geometrically translating bending moments resulting from roof loads into pure forces (tension and compression) where possible, this minimizes bending forces from imposed roof loads, thus reducing material usage.

Another object of the present invention is that of providing a cantilever design where an upright supporting member is positioned so as to minimize the effects of the cantilevered roof loads while also allowing unhindered access to vehicles and car parking spaces.

Another object of the present invention is that of providing carport structures that can be easily combined together to obtain a one- or two-row (back to back) configuration.

Another object of the present invention is that of providing a carport structure whose roof can be mounted at different angles from ground level.

Another object of the present invention is that of using the solar panels themselves to completely seal the roof from water ingress, thus eliminating the need for a secondary waterproof membrane.

Not last object of the present invention is that of providing carport structures designed to support a large variety of solar panels of different type and size.

These and other objects of the present invention, that will be better apparent below, are attained by a modular carport structure comprising one upright member, a cantilever roof structure supported by said upright member, and star-like connecting means supporting and connecting said cantilever roof structure to said upright member characterized in that said upright member, in use, extends upwards from ground inclined forward or backward with respect to a vertical axis.

Further aspects and advantages of the present invention will be better apparent from the following detailed description of currently preferred embodiments of a carport structure according to the invention, given by way of an illustrative and not limiting example with reference to the accompanying drawings, in which:

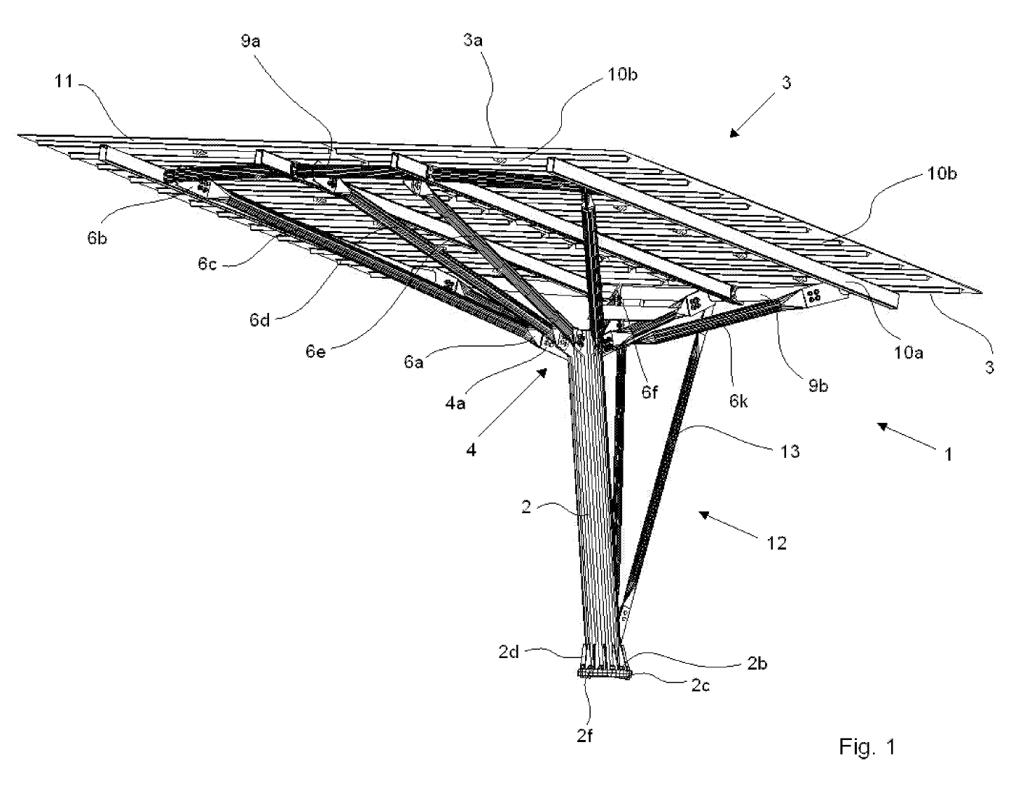

FIG. 1 is a perspective view slightly from below of a modular carport structure according to a first embodiment of the present invention;

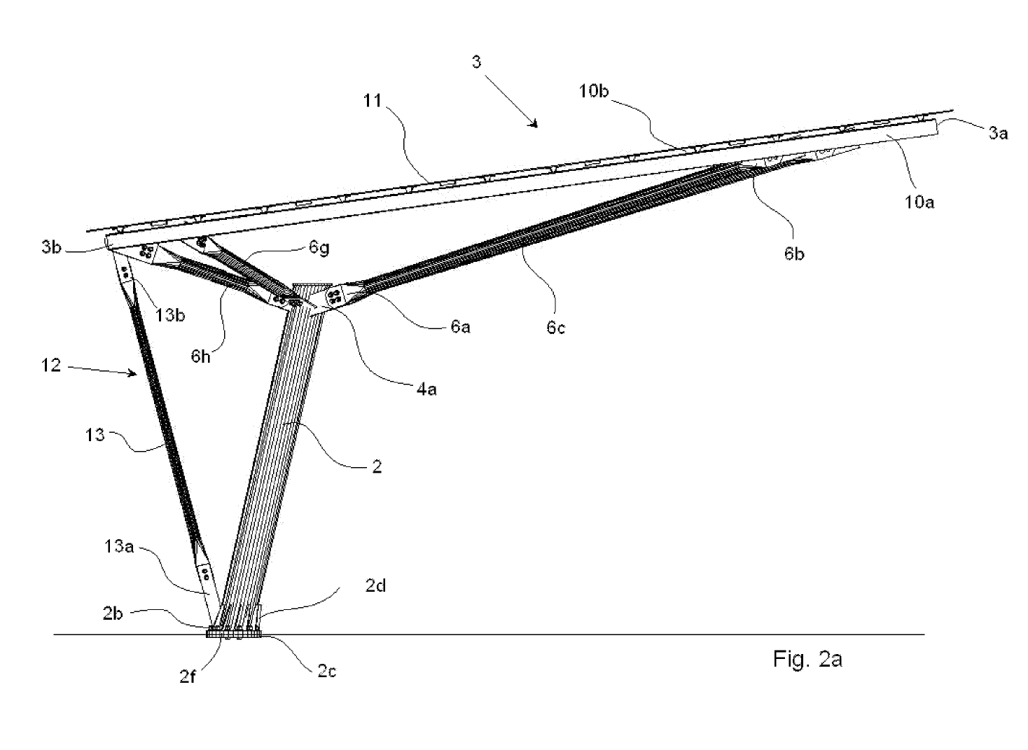

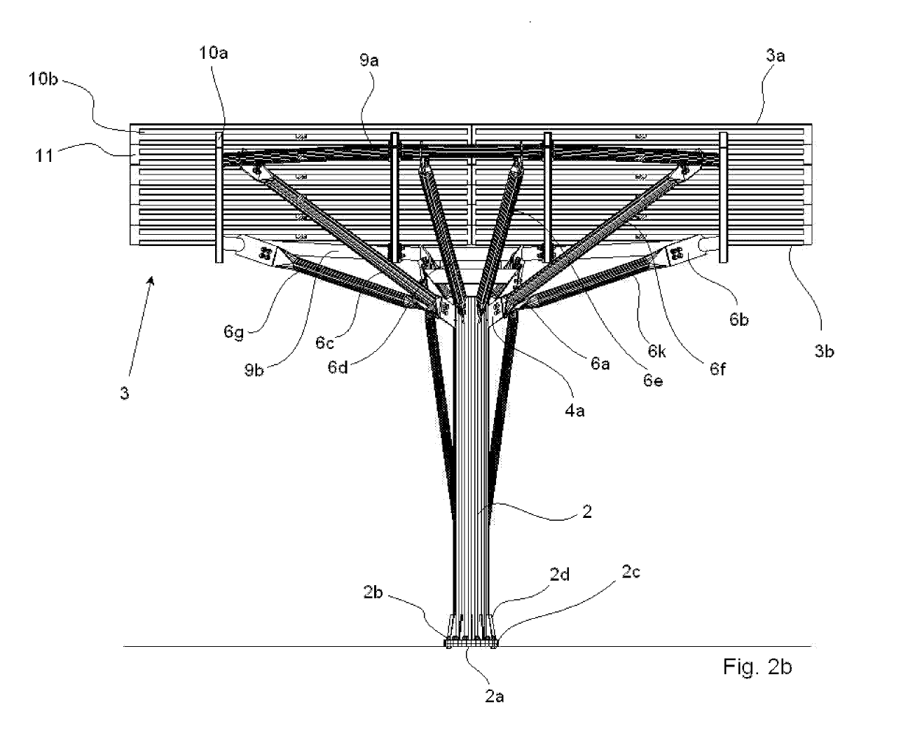

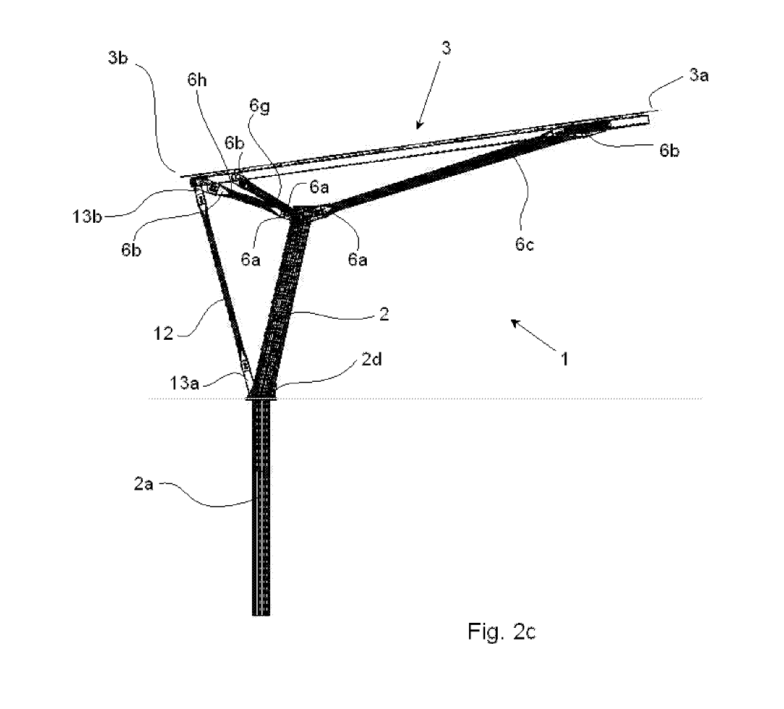

FIGS. 2a and 2b illustrate a side and a front view, respectively, of the modular carport structure of FIG. 1;

FIG. 2c is a side view of the modular carport structure of FIG. 1 and the foundation thereof;

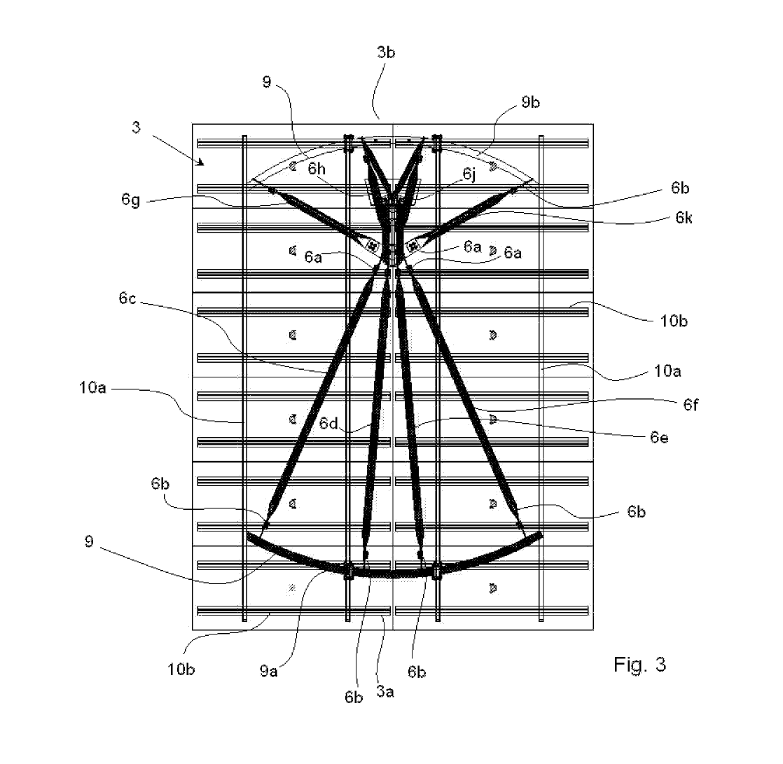

FIG. 3 is a view from below of the modular carport structure of FIG. 1;

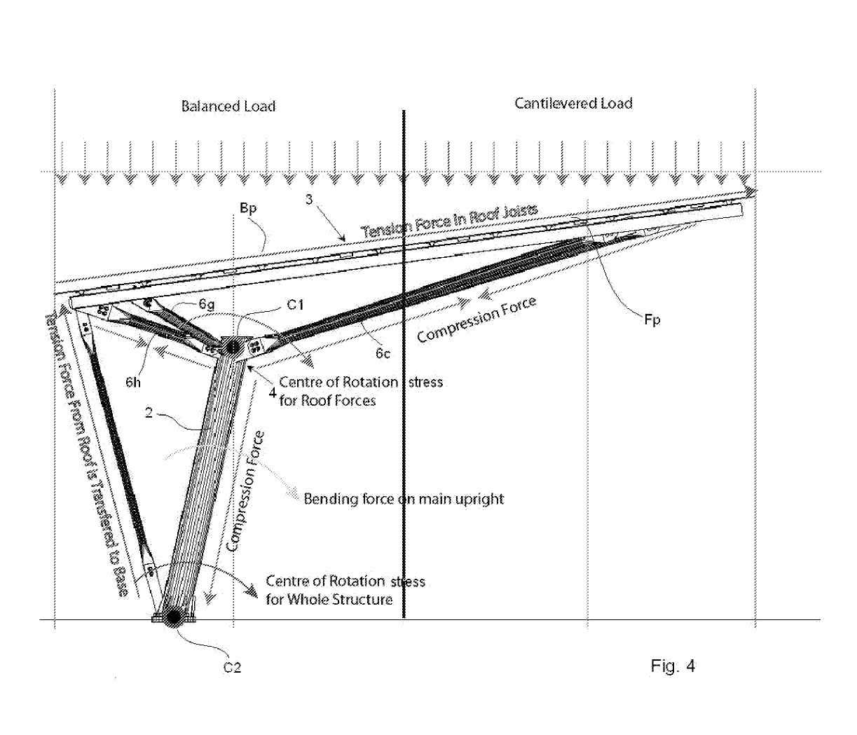

FIG. 4 shows a force diagram for a modular carport structure according to the present invention shown in FIGS. 1 to 3;

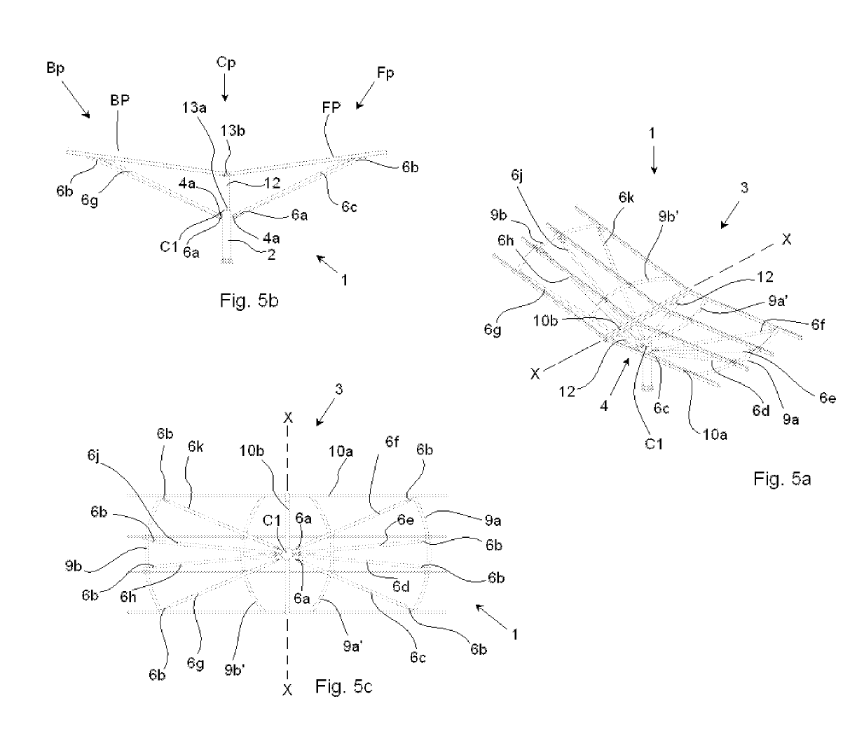

FIG. 5a is a perspective view from above of a modular carport structure in a back-to-back configuration according to a second embodiment of the present invention;

FIG. 5b shows a side view of the modular carport structure of FIG. 5a;

FIG. 5c is a view from below of the modular carport structure of FIG. 5a;

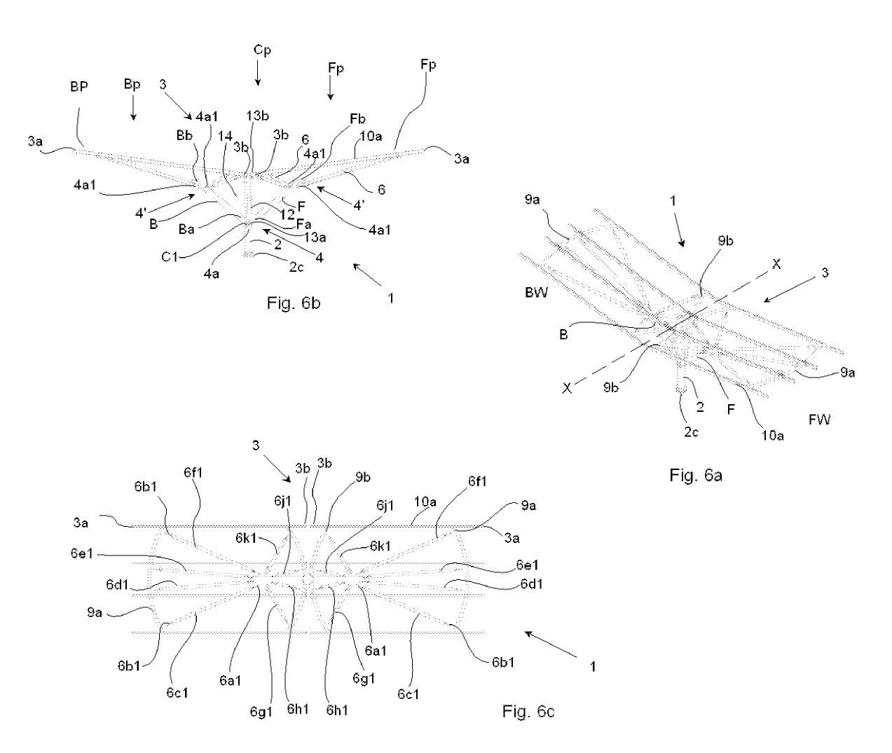

FIG. 6a is a perspective view from above of a modular carport structure in a back-to-back configuration according to a third embodiment of the present invention;

FIG. 6b shows a side view of the modular carport structure of FIG. 6a;

FIG. 6c is a top view of the modular carport structure of FIG. 6a;

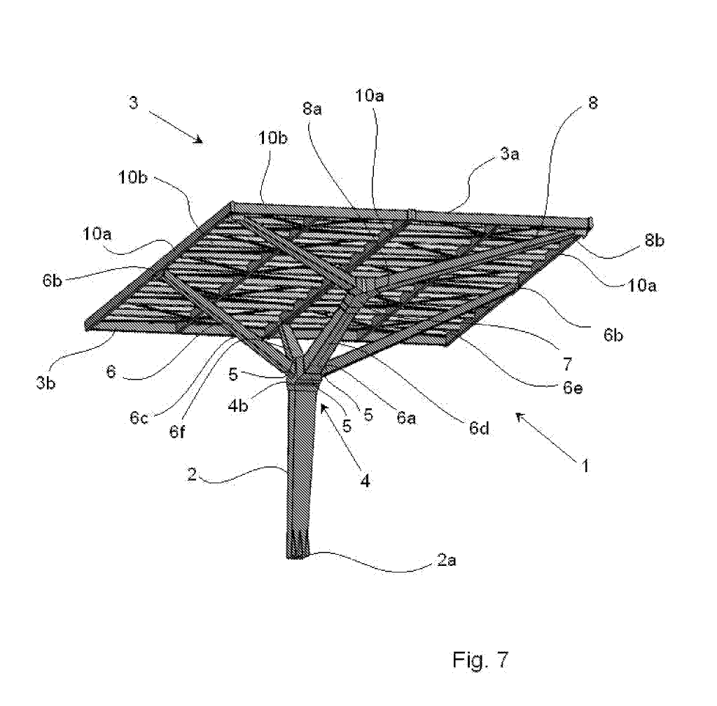

FIG. 7 is a perspective view slightly from below of a modular carport structure according to a fourth embodiment of the present invention;

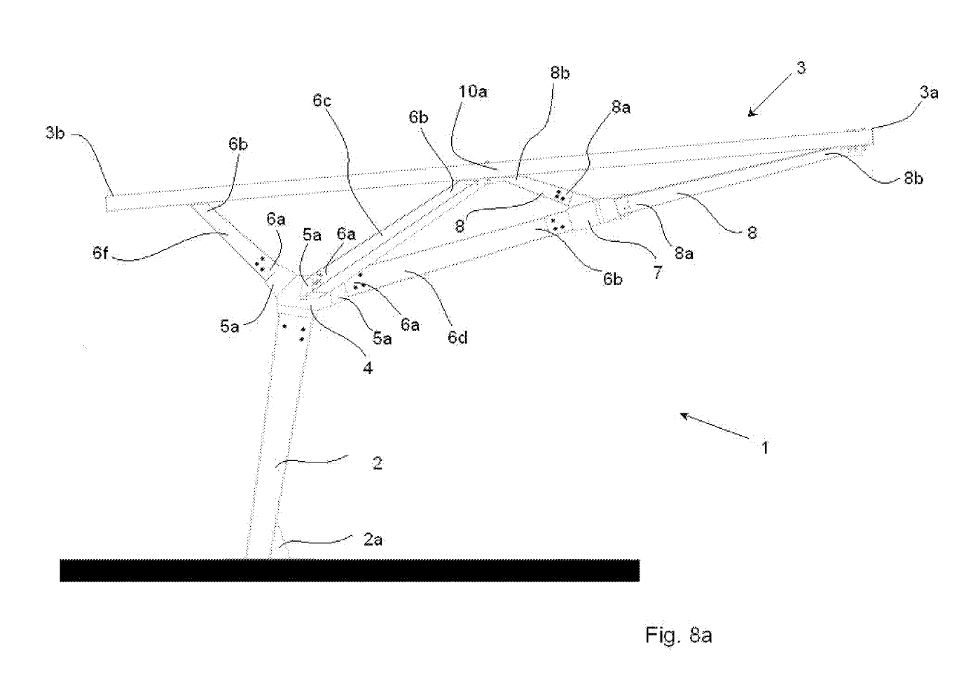

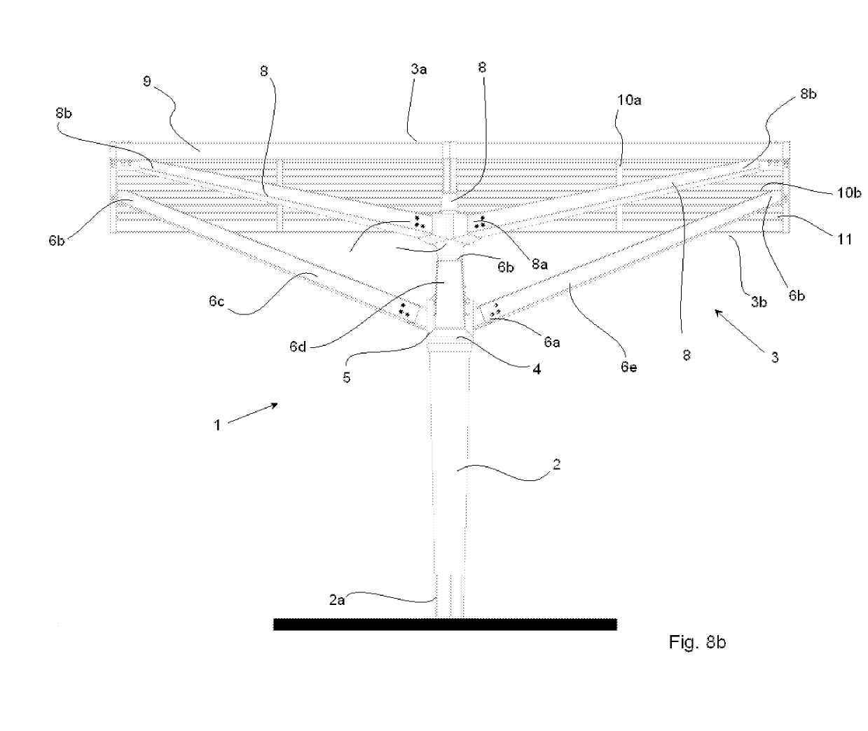

FIGS. 8a and 8b show a side and a front view, respectively, of the carport structure of FIG. 7;

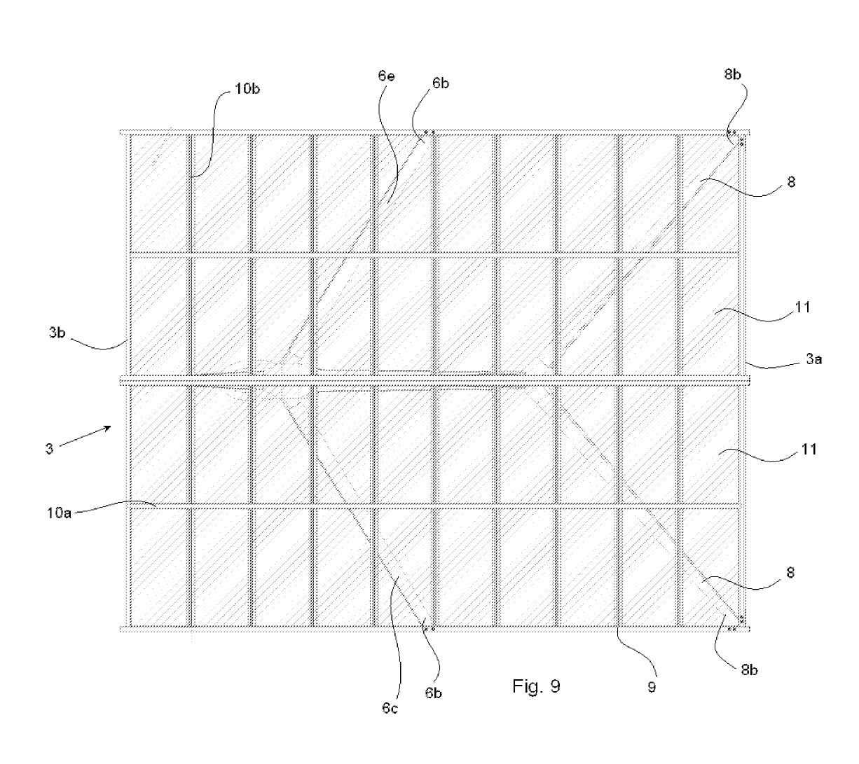

FIG. 9 illustrates a top view of the carport structure of FIG. 7;

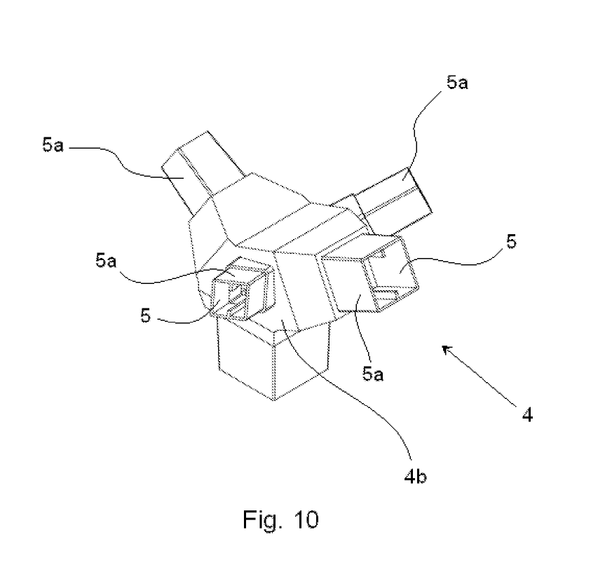

FIG. 10 is a star joint of the carport structure shown in FIGS. 7 to 9;

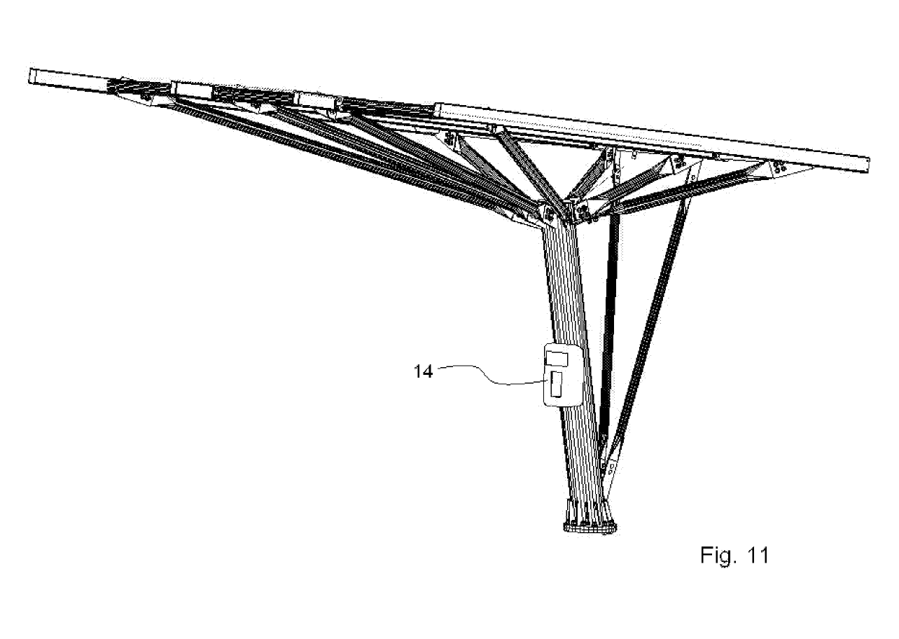

FIG. 11 shows a perspective view of a carport structure according to the present invention provided with a battery charging unit for electric vehicles;

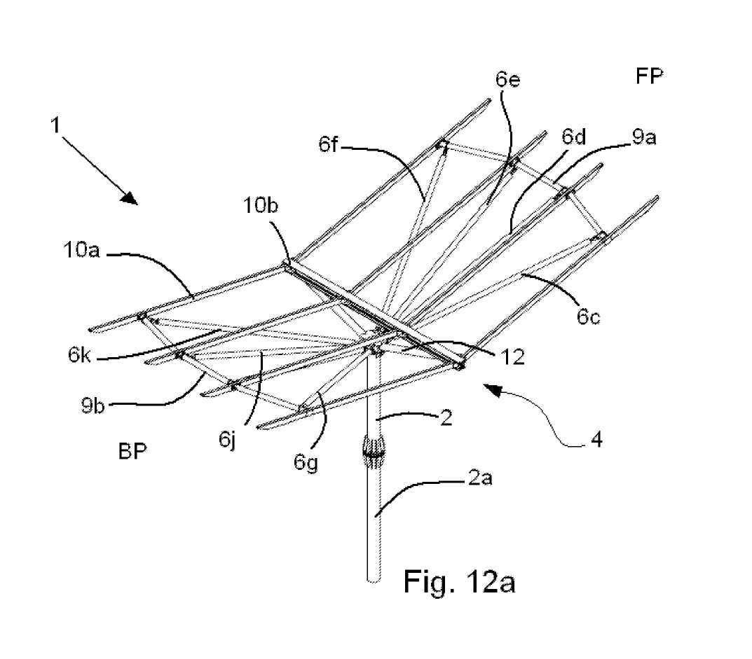

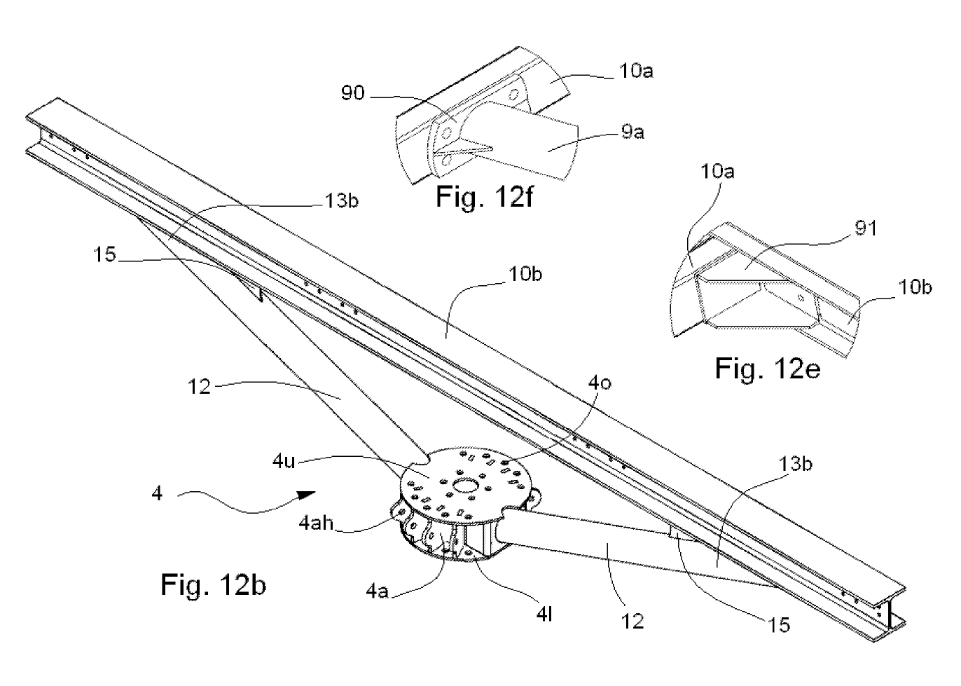

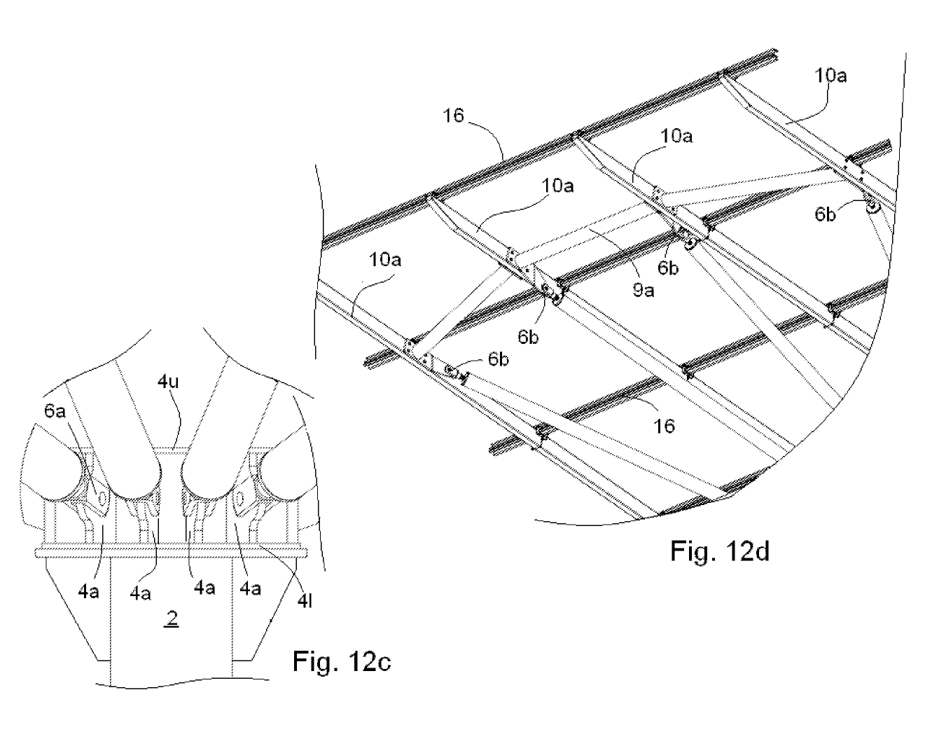

FIG. 12a is a perspective view slightly from above of a modular carport structure according to another embodiment of the present invention;

FIGS. 12b and 12c show star-like connecting means for the carport structure illustrated in FIG. 12a;

FIG. 12d shows a detail of a carport structure of FIGS. 12a to 12c;

FIGS. 12e and 12f show a detail of a carport structure of FIGS. 12a to 12d;

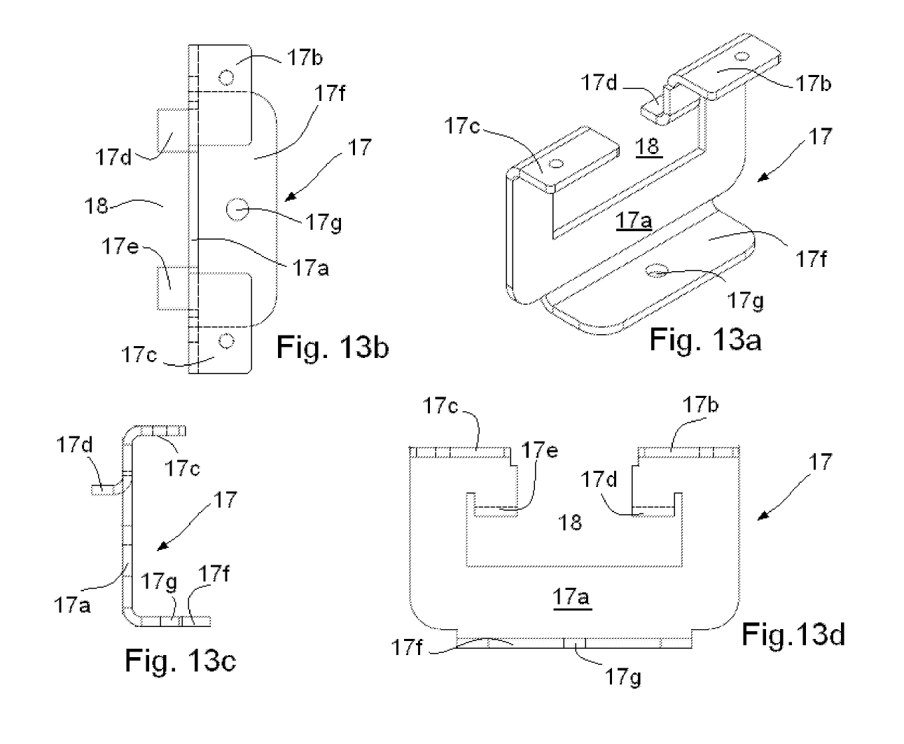

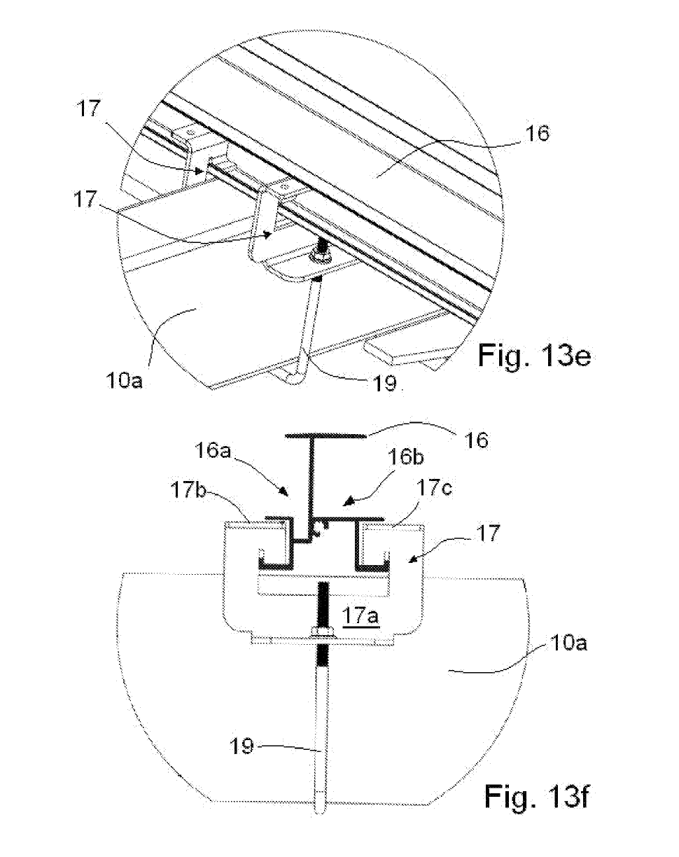

FIGS. 13a to 13d show a perspective view slightly from above, a top view, a side view and a front view, respectively, of bracket means for connecting a transversal rafter designed to support, in use, a PV module, to a longitudinal rafter of roof structure; and

FIGS. 13e and 13f show the connection between a longitudinal and a transversal rafter, using bracket means of FIGS. 13a to 13d.

In the accompanying drawings, the same or similar parts or components have been indicated with the same reference numerals.

With reference first to FIGS. 1 to 3 illustrating a first embodiment of a modular carport structure according to the present invention, it will be noted that a modular carport structure 1 comprises an upright member 2, e.g. a tubular member, preferably made of heavy gauge steel, and designed to support a roof structure 3. The upright member 2 is preferably anchored to a foundation 2a by a number of bolts 2b extending throughout a bottom flange 2c thereof, which is stiffened by a plurality of brackets 2d angularly spaced from one another around the flange 2c. Foundation 2a is preferably of a micropile-type so as to minimize surface disturbance, with a concrete reinforcement and extends into the ground for about 3 meters so as to be completely concealed below ground level. The flange 2c is secured, e.g. bolted, to a top flange 2f of the pile foundation 2a.

The upright member 2 extends upwards from the bottom flange 2c with an inclination in the range from −15° to +15° with respect to a vertical axis. In the described embodiment, the upright member 2 has a forward inclination, thereby defining a front and a back, in use.

The modular carport structure also comprises star-like connecting means 4 located at the upper portion of the upright member 2 and designed to support and connect the roof structure 3 to the upright member 2. More particularly, according to a first embodiment of the present invention, the star-like connecting means 4 comprises a plurality of bracket members 4a secured to, and angularly spaced from one another around the upper portion of the upright member 2. Each bracket member 4a is, in turn, designed to be secured, by means of bolts or other securing means of any suitable kind, to one proximal end 6a of a respective cantilever beam element 6c, 6d, 6e, 6f, 6g, 6h, 6j and 6k (preferably tubular in cross section) whose other distal end 6b is designed to be secured to the roof structure 3.

With specific reference to FIGS. 2a, 2b, and 3, the star-like connecting means 4 comprises eight tubular cantilever compression beam elements, four of which 6c, 6d, 6e and 6f are longer than the others and extend substantially radially and slightly upwards toward the front of the upright member 2, i.e. in an overall direction in which the cantilever range of roof structure 3 is larger.

The other four beam elements 6g, 6h, 6j and 6k extend substantially radially and slightly upwards in an overall opposite back direction. Distal ends 6b of beam elements 6c, 6d, 6e and 6f are at a higher level (with respect to ground) than distal ends 6b of beam elements 6g, 6h, 6j and 6k. As illustrated in FIG. 3, all distal ends 6b of beam elements 6c, 6d, 6e and 6f are secured to the cantilever roof structure 3 through a front cross member 9a, whereas the distal ends of beam elements 6g, 6h, 6j and 6k are anchored, preferably bolted, to a back cross member 9b.

Cross members 9a and 9b delimit a support plane for the roof structure 3, whose inclination ranges from 0° to 35° with respect to a horizontal plane. With this configuration, roof structure 3 can have a front upper edge 3a about 3.5 m high from ground and a back lower edge 3b about 3 m high from ground.

Cross members 9a and 9b preferably have a curved configuration, e.g. each extends along a circumference section having its center on the upright member 2, and are secured, e.g. welded or bolted, to the sides or underneath roof structure 3.

More particularly, cross member 9a is closer to the front upper edge 3a and cross member 9b is closer to the back lower edge 3b of roof structure 3. The cantilever roof structure 3 can typically have overall dimensions of about 6.5×5.5 square meters, and comprises a plurality of longitudinal and transversal rafters (10a and 10b, respectively) which define a supporting grid for receiving and supporting a plurality of plate-like elements 11, preferably solar panels, and most preferably photovoltaic panels (or PV), e.g. twelve panels, electrically connectable to a control electronic circuitry (not shown in the drawings) advantageously located in the tubular upright member 2 in any suitable manner. Should the beam elements 6 being of tubular configuration, electric cabling connecting the PV panels to the electronic circuitry in the upright member 2 can be housed in the beam elements.

In particular, rafters 10a and 10b are advantageously made of rectangular or tubular steel, providing a flat plane onto which any receiving system can be added for the side or underside mounting of any PV panel.

With this configuration an easy and rapid connection can also be established between PV panels and rafters 10a and 10b, thus eliminating the need for an additional mounting rail system of the kind usually employed for mounting conventional PV panels. It will be also appreciated that such a connection system between PV panels and rafters 10a and 10b is most advantageous, since any kind of thin film or crystalline PV panel can be mounted on top of the cantilever roof structure 3. If desired, the control electronic circuitry of the PV panels can be, in turn, electrically connected to one or more user's units, e.g. a lighting circuit for illuminating the space underneath roof structure 3, or a vehicle battery charging unit 14 supported by the upright member 2, as illustrated in FIG. 10.

The modular carport structure 1 according to the present invention is preferably water-resistant. As a matter of fact, PV panels can be mounted one adjacent to the other leaving a gap of only a few millimeters, e.g. 5 mm, between adjacent edges, and a sealant means, e.g. silicone or another suitable sealant, is applied to connect adjacent edges so as to fill the gap therebetween. Thus, the need for a secondary waterproof membrane, usually provided on top of conventional PV panels, is eliminated.

The above described modular carport structure 1 can be advantageously provided with tie members 12, preferably tubular tie members (two in number in FIGS. 1 to 3), each having a lower end 13a anchored to the lower portion of the upright member 2, and an upper end 13b anchored to roof structure 3, e.g. to the cross member 9b closer to the back lower edge 3b thereof. Such tie members 12 are designed to reduce the bending moment of the cantilever roof structure 3 and to help convert bending forces into a compression force on the upright member 2, thereby also reducing bending forces on the upright member.

With this configuration, the modular carport structure 1 is stable even in severe windy or snowy conditions.

Referring now to FIG. 4, showing a simplified force diagram for the carport according to the first embodiment of the present invention, it will be noted that the particular configuration of cantilever beam elements 6c, 6d, 6e, 6f, 6g, 6h, 6j and 6k and their connection with roof structure 3, reduces the bending stresses on longitudinal rafters 10a, thereby allowing the overall mass of the carport structure 1 to be minimized.

More particularly, longitudinal and transversal rafters 10a and 10b are offset from the top of upright member 2, by means of cantilever compression beam elements 6c, 6d, 6e, 6f, 6g, 6h, 6j and 6k, so that the roof structure 3 of the carport can be divided into two portions: a back portion Bp, where any imposed load is balanced, and a front cantilever portion Fp.

The particular configuration of cantilever beam elements and their connection with roof structure 3, helps translating bending forces from imposed loads on the front portion Fp of the roof structure 3 into tension forces, through rafters 10a and 10b and tie members 12, around a rotational fulcrum connection point C1 at the top of upright member 2 and back to the base C2 of the main upright 2. This conversion of bending forces into pure forces (tension and compression) greatly increases the structural efficiency of the carport structure and allows to reduce size and mass of the carport components, thereby reducing loads at the base of the main upright 2d.

FIGS. 5a to 5c show a second embodiment of a modular carport structure 1 according to the present invention in a so called back-to-back configuration. The carport structure 1 comprises a tubular upright member 2, e.g. circular in cross section, designed to support a cantilever roof structure 3 preferably anchored to a micropile-type foundation 2a as described in the first embodiment of the present invention.

The upright member 2 extends vertically upwards from a bottom flange 2c and is provided at the upper portion thereof with star-like connecting means 4. The star-like connecting means 4 comprises a plurality of bracket members 4a of the type described with reference to the first embodiment of the present invention. Each bracket member 4a is designed to be secured, by means of bolts or other securing means of any suitable kind, to one proximal end 6a of a respective cantilever beam element 6c, 6d, 6e, 6f, 6g, 6h, 6j and 6k (preferably tubular in cross section) whose other distal end 6b is designed to be secured to the roof structure 3.

The star-like connecting means 4 comprises eight tubular cantilever compression beam elements, all having the same length. As for the first embodiment of the present invention, four of the eight tubular cantilever compression beam elements, more particularly beam elements 6c, 6d, 6e and 6f, extend substantially radially and slightly upwards toward a front of upright member 2, the other four beam elements 6g, 6h, 6j and 6k extend substantially radially and slightly upwards in an overall opposite, thereby defining a front and a back in use.

Distal ends 6b of all beam elements 6c, 6d, 6e, 6f, 6g, 6h, 6j and 6k are at the same level (with respect to ground). As illustrated in FIG. 5a, all distal ends 6b of beam elements 6c, 6d, 6e and 6f are secured to the cantilever roof structure 3 through a front cross member 9a, whereas the distal ends of beam elements 6g, 6h, 6j and 6k are anchored, preferably bolted, to a back cross member 9b.

Cross members 9a and 9b preferably have a curved configuration, and extend along a circumference section having its center on the upright member 2. They are secured, e.g. welded or bolted, to the sides or underneath roof structure 3.

The cantilever roof structure 3 comprises a plurality of longitudinal rafters 10a and one transversal 10b which define a supporting grid for receiving and supporting a plurality of plate-like elements 11 as those described with reference to the first embodiment of the present invention.

The transversal rafter 10b is provided above the top of upright member 2 at a lower level than cross members 9a and 9b. Cross members 9a and 9b are, for example, about 3.5 m high form ground, while the transversal rafter 10b is at about 3 m from ground.

With this configuration, roof structure 3 has a front FP and a back pitch BP, each pitch having overall dimensions of about 6.5×5.5 square meters, and being suitable for sheltering two vehicles. More particularly, as illustrated in FIG. 5b, both pitches FP and BP of roof structure 3 are inclined with respect to one another and converge towards a horizontal line (x-x) (transversal rafter 10b) in a vertical plane containing upright member 2. The horizontal line (x-x) is located at a lower level than pitches FP and BP.

Optionally, the carport according to the second embodiment of the present invention is provided with auxiliary cross members 9a′ and 9b′, which are configured as cross members 9a and 9b and designed to connect longitudinal rafters 10a with each other.

The modular carport structure 1 according to the second embodiment of the present invention can be advantageously provided with tie members 12 as those described with reference to the first embodiment. Each tie member 12 has a lower end 13a anchored to the top of upright member 2, and an upper end 13b anchored to roof structure 3, e.g. to transversal rafter 10b.

The roof structure 3 of the carport according to the second embodiment of the present invention can be divided into three portions: a central portion Cp where any imposed load is balanced, and two cantilevered portions, a front Fp and a back Bp portion, respectively.

The particular configuration of cantilever beam elements (6c, 6d, 6e, 6f, 6g, 6h, 6j and 6k) and their connection with roof structure 3, helps translating bending forces from imposed loads on the front Fp and back Bp portions of the roof structure 3 into tension forces, through rafters 10a and 10b and tie members 12, around a rotational fulcrum connection point C1 at the top of upright member 2 and to its base. This conversion of bending forces into pure forces (tension and compression) greatly increases the structural efficiency of the carport structure and allows to reduce size and mass of the carport components, thereby reducing loads at the base of the main upright 2d.

With reference, now, to FIGS. 6a to 6c that show a third embodiment of a modular carport structure 1 according to the present invention, it will be noted that the carport structure 1 comprises a vertical tubular upright member 2, designed to support a cantilever roof structure 3, and is preferably anchored to a micropile-type foundation 2a.

The modular carport structure comprises star-like connecting means 4 located at the upper portion of the upright member 2 and designed to support and connect the roof structure 3 to the upright member 2. The star-like connecting means 4 comprises a pair of bracket members 4a of the type described with reference to the first and second embodiment of the present invention, each bracket members 4a being designed to be secured to one proximal end Fa, Ba of a respective member of a pair if opposite supporting tubular members F, B (preferably tubular in cross section), whose other distal end Fb, Bb is designed to be secured to a plurality of auxiliary star-like connecting means 4′.

Such opposite supporting tubular members F and B extend angularly upwards from upright member 2 with an inclination angle with respect to a vertical axis, thereby defining, in use, a front Fp and a back Bp of the carport 1.

The auxiliary star-like connecting means 4′ comprises a plurality of bracket members 4a1. Each bracket 4a1 is secured to, and angularly spaced from one another around the upper portion of a respective supporting tubular member F or B, and is designed, in turn, to be secured, by means of bolts or other securing means of any suitable kind, to one proximal end 6a1 of a respective auxiliary cantilever beam element 6c1, 6d1, 6e1, 6f1, 6g1, 6h1, 6j1 and 6k1 (preferably tubular in cross section) whose other distal end 6b1 is designed to be secured to roof structure 3.

The auxiliary star-like connecting means 4′ comprises two sets of eight auxiliary tubular cantilever compression beam elements, one for each supporting tubular member F and B. Auxiliary cantilever compression beam elements 6c1, 6d1, 6e1 and 6f1 of each set are longer than the others and extend substantially radially and slightly upwards in an overall direction where the cantilever range of roof structure 3 is larger. More particularly, the auxiliary cantilever compression beam elements 6c1, 6d1, 6e1 and 6f1 secured to supporting tubular member F extend toward a front portion Fp of the carport structure 1, while the auxiliary cantilever compression beam elements 6c1, 6d1, 6e1 and 6f1 secured to supporting tubular member B extend toward a back portion Bp of carport 1.

The other four auxiliary beam elements of each set 6g1, 6h1, 6j1 and 6k1 extend substantially radially and slightly upwards in an overall opposite direction with respect to auxiliary beam elements 6c1, 6d1, 6e1 and 6f1, i.e. toward a central portion Cp of roof structure 3. Distal ends 6b1 of beam elements 6c1, 6d1, 6e1 and 6f1 are at a higher level (with respect to ground) than distal ends 6b1 of beam elements 6g1, 6h1, 6j1 and 6k1.

All distal ends 6b1 of auxiliary beam elements 6c1, 6d1, 6e1 and 6f1 of a same set are secured to the cantilever roof structure 3 through a cross member 9a, whereas distal ends of auxiliary beam elements 6g1, 6h1, 6j1 and 6k1 of a same set are anchored, preferably bolted, to a cross member 9b. Cross members 9a and 9b preferably have a curved configuration, e.g. each extends along a circumference section having its center on the upper portion of the respective supporting tubular member F and B, and are secured, e.g. welded or bolted, to the sides or underneath roof structure 3.

Each couple of cross members 9a and 9b for a respective set of auxiliary beam elements 6c1, 6d1, 6e1, 6f1, 6g1, 6h1, 6j1 and 6k1 delimit a support plane for the roof structure 3, whose inclination ranges from 0° to 35° with respect to a horizontal plane, and whose upper edge 3a is at about 3.5 m from ground, the lower edge being at about 3 m from ground.

The cantilever roof structure 3 comprises a plurality of longitudinal and transversal rafters 10a, 10b which define a supporting grid for receiving and supporting a plurality of plate-like elements 11 as those described with reference to the first and second embodiment of the present invention.

With this configuration, roof structure 3 has a front FP and a back pitch BP, each pitch having overall dimensions of about 6.5×5.5 square meters, and being suitable for sheltering two vehicles. More particularly, as illustrated in FIG. 6b, both pitches FP and BP of roof structure 3 are inclined with respect to one another and converge towards a horizontal line (x-x) in a vertical plane containing upright member 2. The horizontal line (x-x) is located at a lower level than pitches FP and BP.

The above described modular carport structure 1 can be advantageously provided with tie members 12, preferably tubular tie members (two in number for each pitch FP and BP of roof structure 3), each having a lower end 13a anchored to the upper portion of upright member 2, and an upper end 13b anchored to roof structure 3, e.g. to the cross members 9b.

The carport according to the third embodiment of the present invention also comprises an additional tie member 14, designed to connect the upper portions of supporting tubular member F and B with each other.

Such tie members 12 and 14 are designed to reduce the bending moment of the cantilever roof structure 3 and to help convert bending forces into a compression force on the upright member 2, thereby also reducing bending forces on the upright member.

As for the second embodiment of the present invention, the roof structure 3 of the carport according to the third embodiment can be divided into three portions: a central portion Cp where any imposed load is balanced, and two cantilevered portions, the front Fp and the back Bp portion, respectively. The particular configuration of cantilever beam elements (6c, 6d, 6e, 6f, 6g, 6h, 6j and 6k) and their connection with roof structure 3, helps translating bending forces from imposed loads on the front Fp and back Bp portions of the roof structure 3 into tension forces, through rafters 10a and 10b and tie members 12 and 14, around a rotational fulcrum connection point C1 at the top of upright member 2 and to its base. This conversion of bending forces into pure forces (tension and compression) greatly increases the structural efficiency of the carport structure and allows to reduce size and mass of the carport components, thereby reducing loads at the base of the main upright 2d.

Reference is made now to FIGS. 7 to 10 that show a fourth embodiment of a modular carport structure 1 according to the present invention, it will be noted that the carport structure 1 comprises a tubular upright member 2, e.g. rectangular in cross section, designed to support a cantilever roof structure 3. As in the embodiments described above, the upright member 2 is preferably anchored to a micropile-type foundation 2a.

The upright member 2 is provided at the top portion thereof with star-like connecting means 4 such as a joint member 4b. Joint member 4b (FIG. 9) is preferably obtained by casting and can be secured to the upright member 2, e.g. by bolting or welding, and delimits a plurality of receiving seats 5, e.g. four receiving seats, which are angularly spaced form one another. Receiving seats 5 extend upwards, in use, at an angle of inclination with respect to an horizontal plane. This inclination angle is typically in the range from about −35° to about +35°.

Each receiving seat 5 is preferably provided with tubular extensions 5a rectangular or circular in cross section for being connected by insertion into a respective tubular beam element. Each beam element has a proximal end 6a that can be removably inserted onto the tubular extension 5a of a respective receiving seat 5, and a distal end 6b designed to be secured to the roof structure 3 (e.g. by means of bolts or the like securing means) or to an additional auxiliary joint member 7 substantially shaped as the joint member 4b.

With specific reference to FIG. 7, one beam element extends towards the forward upper edge 3a of roof structure 3 and has its distal end 6b insertable into a respective receiving seat 7a of the auxiliary joint member 7 that, in turn, can be coupled to a plurality (e.g. three) of auxiliary beam elements 8, each having a proximal end 8a, in use, removably fit insertable into a respective receiving seat of the auxiliary joint member 7, and a distal end 8b directly connectable to the roof structure 3. The distal ends 8b of the auxiliary beam elements 8, and the distal ends 6b of the beam elements, with the exception of the beam element 6d extending between the joint members 4b and 7, define a supporting plane for the roof structure 3.

It will be noted that, the modular carport structure 1 according to the fifth embodiment can also be provided with tie members 12 fully similar to those described in connection with the other embodiments of the present invention.

It will also be noted that such a carport structure 1 can be readily mounted even on sloping grounds, since the use of a single upright member 2 allows to handle ground irregularities with ease.

The above described modular carport structure is susceptible to numerous modifications and variations within the scope of the invention as defined by the claims.

Thus, for example, with reference to FIGS. 12a to 12f, the star-like connecting means 4 comprises
a lower plate annular element 4l, designed to be fit inserted onto the upper end of the main upright 2 and supported by a plurality of support brackets 4s;
an inner sleeve member 4m secured to said lower plate annular element 4l and provided with a plurality of bracket members 4a angularly arranged around an axis y-y;
an upper plate element 4u resting on, and secured to, said sleeve member 4m and fixed, e.g. bolted, to the top of main upright 2; and
at least two tie members 12 secured, e.g. welded or bolted, to the inner sleeve member 4m and to roof structure 3, e.g. to transversal rafter 10b, thereby forming therewith a triangular rigid structure.

A plurality of through openings 4o is also formed in both plate elements 4l and 4u of star like connecting means 4, wherein an opening 4o in the lower plate element 4l is, in use, aligned with a respective opening 4o of the upper plate element 4u. Each couple of aligned openings 4o act as receiving seats for locking means of any suitable kind, e.g. a bolt not illustrated in the drawings, to connect and stiffen plate elements 4l and 4u with each other.

Each bracket member 4a has a through hole 4ah for pin connection to one proximal end 6a of a respective cantilever beam element 6c, 6d, 6e, 6f, 6g, 6h, 6j and 6k (preferably tubular in cross section).

More particularly, the connection between a proximal end 6a of each cantilever beam element (6c, 6d, 6e, 6f, 6g, 6h, 6j and 6k) with its respective bracket member 4a (see FIG. 12c) is obtained through a clevis-pin arrangement. The distal end 6b of each cantilever beam element (6c, 6d, 6e, 6f, 6g, 6h, 6j and 6k) can be pivoted to a respective cross member 9a, 9b (see FIG. 12d).

A cross member 9a, 9b can extend along three adjacent sides of a polygon centered on the upright member 2. Each segment of cross members 9a and 9b, as illustrated in FIG. 12d, can also be secured, e.g. welded or bolted, to respective longitudinal rafters 10a, e.g. by making use of a flanged end 90 (FIG. 12f).

FIG. 12e shows a preferable connection between a longitudinal rafter 10a and the transversal rafter 10b of the carport structure of FIG. 12a. Such connection is obtained by making use of inner connection webs 91.

Advantageously, the carport structure is provided with stiffening means 15 arranged to connect the upper portion 13b of tie members 12 of the carport structure to transversal rafter 10b, thereby obtaining a more rigid connection therebetween.

It will be noted that with this type of star-like connecting means 4 the angle of roof structure 3 with respect to an horizontal plane can be easily changed by varying the position of cross members 9a and/or 9b with respect to longitudinal rafters 10a. The carport structure 1 can be readily mounted even on sloping grounds, since the use of a single upright member 2 allows to handle ground irregularities with ease.

More particularly, given the particular configuration of the star-like connecting means 4 according to FIGS. 12a to 12e, by employing compression beam elements of different length and/or securing the distal ends thereof at different distance along longitudinal rafters 10a, it is possible to easily change the slope of roof structure 3 with respect to the ground, thereby always obtaining a maximum covering area for vehicles parked underneath the carport structure.

Roof structure 3, as already stated above, is arranged to support PV modules 11 of any size. It is to be noted that the carport structure illustrated in FIGS. 12a to 12f allows roof structure 3 to be oriented so as to maximize solar radiation levels. To this aim, one pitch of roof structure, e.g. facing North, can be placed at an angle ranging from 0 to −10 degrees with respect to an horizontal plane, and the other pitch, facing South, can be orientated at an angle ranging from 0 to +35 degrees with respect to the same horizontal plane. With this orientation of roof structure 3 it is possible to maximize the annual generation of solar energy. Given the particular configuration of beam elements (6c, 6d, 6e, 6f, 6g, 6h, 6j and 6k), it is clear that the inclination of each pitch FP, BP of roof structure 3 can be set according to the needs.

The supporting grid for supporting PV modules can preferably comprise a plurality of PV mounting rails 16, which can be connected to a longitudinal rafter 10a at a desired distance therealong by means of PV bracket members 17 shown in FIGS. 12a to 12f.

Referring now to FIGS. 13a to 13d, it will be noted that a PV bracket member 17 comprises a “U-shaped” plate-like main body 17a delimiting a coupling area 18 for connection with both sides (16a, and 16b) of a PV mounting rail 16. To this aim, free ends (17b, and 17c) of the “U-shaped” plate-like main body 17a are orthogonally bent with respect to main body 17a and are each provided with a lower tongue 17d and 17e also bent in an orthogonal direction with respect to main body 17a in opposite direction. The main body 17a of each PV bracket member 17 also has a lower tongue 17f which is bent according to the free ends 17d and 17c and is also formed with a through hole 17g for receiving suitable locking means 19.

With such a configuration, see FIGS. 13e and 13f, coupling between a PV mounting rail 16 and a PV bracket member 17 is obtained by inserting a PV mounting rail 16 into the coupling area 18 of the PV bracket member 17, which results in the PV bracket member 17 being supported by the PV mounting rail 16 at its lower tongues 17d and 17e

The connection between a longitudinal rafter 10a and a PV mounting rails 16 is obtained by first placing the PV mounting rail 16 on the longitudinal rafter 10a in a cross configuration, the PV mounting rail 16 being already coupled to two PV bracket members 16. Each PV bracket member is brought in contact with a respective side of longitudinal rafter 10a so that it has its lower tongue 17f directed outwardly. A locking means of any suitable kind, e.g. a U-bolt, can be used to secure the two PV bracket members 17, and consequently the PV mounting rail 16, on top of longitudinal rafter 10a.

If desired a metal or plastic sheet can be mounted between PV mounting rails 16 and top surface of longitudinal rafters 10a in order to hide electric cables running underside PV modules 11.

The upright member 2 as well as the beam elements and the auxiliary beam elements 8 can be tapered in shape, thereby allowing a reduction in manufacture materials and weight.

The number of longitudinal rafters 10a and corresponding compression beam elements (6b, 6c, 6d, 6e, 6f, 6g, 6h, 6j, 6k) can also be reduced in order to minimize load cases.

It is to be noted that with such a configuration of a carport structure 1, the roof structure 3 can be entirely assembled at ground level, complete with transversal rafters 10b and/or PV mounting rails 16 and PV modules 11, and then lifted into place on top of the main upright 2, thus eliminating the need of working at height and reducing installation time and the need of heavy lifting equipment usually required for conventional roof assembly.

The carport structure 1 can also be provided with a gutter element at a lower portion 3b of roof structure 3. The carport structure can also be made of engineered wooden materials, such as Gluelam or Kerto® available, for example, from Finnforest Italia S.r.l. (Milano, ITALIA). This would further reduce the environmental impact required to manufacture it.

Of course, the above described modifications and variations do apply to any previously disclosed embodiment of the invention.

1-49. (canceled)

50. A modular carport structure comprising one upright member, a cantilever roof structure supported by said upright member, and star-like connecting means supporting and connecting said cantilever roof structure to said upright member,
said upright member, in use, extending upwards from ground inclined forward or backward with respect to a vertical axis;
said cantilever roof structure extending, in use, on one plane inclined with respect to an horizontal plane, thereby having a forward upper edge and a back lower edge;
said star-like connecting means comprising:
a plurality of bracket members angularly spaced form one another around said upright member and secured to said upright member, and
a plurality of beam elements each having a proximal end securable to a respective bracket member on said upright member, and wherein the proximal end of each beam element is connectable to a respective bracket member through a clevis-pin arrangement, and a distal end of each beam element is securable to said cantilever roof structure, and in that at least two tie members are secured to said roof structure, and to said upright member thereby forming therewith a triangular rigid structure.

51. A structure as claimed in claim 50, wherein said distal ends of said beam elements are secured to said roof structure through cross members delimiting a support plane for said roof structure.

52. A structure as claimed in claim 50, wherein said star-like connecting means comprises a plurality of beam elements each having a distal end pivoted to a respective cross member.

53. A structure as claimed in claim 51, wherein said cross members extend along at least one circumference section having its center on the upright member.

54. A structure as claimed in claim 51, wherein said cross members extends along at least one side of a polygon centered on the upright member.

55. A modular carport structure comprising one upright member extending, in use, along a substantially vertical axis, a cantilever roof structure supported by said upright member, and star-like connecting means supporting and connecting said cantilever roof structure to said upright member, said cantilever roof structure cantilever-wise extending forwards and backwards with respect to said upright member, and comprising two planes or pitches inclined with respect to one another and converging towards a horizontal line in a vertical plane containing said upright member located at a lower level than said planes or pitches;
said star-like connecting means comprising:
a plurality of bracket members angularly spaced form one another around said upright member and secured to said upright member, and
a plurality of beam elements each having a proximal end securable to a respective bracket member of said upright member, and
wherein the proximal end of each beam elements is connectable to a respective bracket member through a clevispin arrangement, and a distal end of each beam element is securable to said cantilever roof structure, and in that at least two tie members secured to said star-like connecting means, and to roof structure, thereby forming therewith a triangular rigid structure.

56. A structure as claimed in claim 55, wherein said distal ends of said beam elements are secured to said roof structure through cross members extending along at least one circumference section having its center on said upright member.

57. A structure as claimed in claim 55, wherein said distal ends of said beam elements are secured to said roof structure through cross members extending along at least one side of a polygon centered on the upright member.

58. A structure as claimed in claim 56, wherein said star-like connecting means comprises a plurality of beam elements each having a distal end pivoted to a respective cross member.

59. A structure as claimed in claim 50, wherein the upper portion of said main upright member acts as a rotational fulcrum for said roof structure, the roof structure being offset from the top of said upright member by said plurality of beam elements.

60. A structure as claimed in claim 50, wherein said cantilever roof structure comprises a plurality of longitudinal and cross rafters defining a support grid for a plurality of plate-like elements and each having a “U”-shaped cross section with concavity facing upwards, thereby delimiting a receiving channel for at least one matching portion of at least one plate-like element.

61. A structure as claimed in claim 50, wherein said cantilever roof structure comprises a plurality of longitudinal rafters and a plurality of PV mounting rails defining a support grid for a plurality of plate-like elements.

62. A structure as claimed in claim 61, wherein
said PV mounting rails are secured to at least one of said longitudinal rafters by means of at least one couple of PV brackets members and a locking means, and in that
each PV bracket member comprises
a “U-shaped” plate-like main body delimiting a coupling area for connection with said PV mounting rail, the free ends of said PV bracket member being orthogonally bent with respect to said main body and each being provided with a lower tongue also orthogonally bent with respect to main body in opposite direction, and
a lower tongue bent according to said free ends of main body, and where a through hole for receiving suitable locking means is formed therein.

63. A structure as claimed in claim 62, wherein said locking means are U-bolts, said U-bolts being designed to secure said couple of PV bracket members mounted on a respective PV mounting rail to a longitudinal rafter.

64. A structure as claimed in claim 60, wherein said plate-like elements are connectable with one another by means of a sealant means.

65. A method for assembling a carport structure according to claim 50, wherein the forward-backward inclination of said main upright with respect to a vertical axis is adjustable to minimize the portion of said cantilever roof structure and the cantilever load onto said roof structure.

66. A method according to claim 65, wherein a variation of the inclination of roof structure with respect to ground is achieved by varying the length of said beam elements.

67. A method according to claim 65, when said carport structure comprises
a roof structure provided with a plurality of longitudinal rafters and cross members, and star-like connecting means comprising beam elements, each having a proximal end connectable to a respective bracket member of said star-like connecting means through a clevis-pin arrangement, and
a distal end pivoted to a respective cross member, wherein a desired inclination of roof structure with respect to ground is achieved by changing the position of said cross members along said longitudinal rafters.
